(19) United States
(12) Patent Application Publication
(10) Pub. No.: US 2024/0078132 A1
(43) Pub. Date: Mar. 7, 2024

(54) SYSTEMS AND METHODS FOR MULTI CLOUD TASK ORCHESTRATION

(71) Applicant: JPMORGAN CHASE BANK, N.A., New York, NY (US)

(72) Inventors: Alex CHRISTODOULOU, Wilmington, DE (US); Ashish K MISHRA, Middletown, DE (US); Pethaperumal NARAYANASAY, Newark, DE (US); Ayesha BEGUM, Middletown, DE (US); Rohit VERANNAGARI, Newark, DE (US); Amitkumar SHAH, Herndon, VA (US); Eric BARNABA, Wilmington, DE (US)

(21) Appl. No.: 18/457,990

(22) Filed: Aug. 29, 2023

Related U.S. Application Data
(60) Provisional application No. 63/373,806, filed on Aug. 29, 2022.

(51) Int. Cl. G06F 9/48; G06F 9/54

(52) U.S. Cl. CPC G06F 9/485; G06F 9/547

(57) ABSTRACT

Systems and methods for multi cloud task orchestration are disclosed. In one embodiment, a method for multi cloud task orchestration may include: (1) creating, by a workflow task function, a first job for a service provided on a container orchestration system, wherein the workflow task function cannot call the service directly; (2) forwarding, by the workflow task function, the first job to the service as a serverless task/function using a request forwarder; (3) waiting, by the workflow task function, for a period of time; (4) checking, by the workflow task function, a status of the first job with the serverless task/function, (5) receiving, by the workflow task function, the status of the first job; and (6) continuing, by the workflow task function, with a second job for the service provided on the container orchestration system.

### RELATED APPLICATIONS

This application claims priority to, and the benefit of, U.S. Provisional Patent Application Ser. No. 63/373,806, filed Aug. 29, 2022, the disclosure of which is hereby incorporated, by reference, in its entirety.

### BACKGROUND OF THE INVENTION

### 1. Field of the Invention

Embodiments relate to systems and methods for multi cloud task orchestration.

### 2. Description of the Related Art

Many applications run within an organization have a batch architecture where jobs are meant to run sequentially on a regular/on-demand basis. To achieve this, an orchestration component must be present to initiate the jobs and handle errors should any occur. Services, such as Amazon Web Service's (AWS) Elastic Kubernetes Service (EKS) and AWS Elastic Container Service (ECS), however, do not have any built-in orchestration component.

### SUMMARY OF THE INVENTION

Systems and methods for multi cloud task orchestration are disclosed. In one embodiment, a method for multi cloud task orchestration may include: (1) creating, by a workflow task function, a first job for a service provided on a container orchestration system, wherein the workflow task function cannot call the service directly; (2) forwarding, by the workflow task function, the first job to the service as a serverless task/function using a request forwarder; (3) waiting, by the workflow task function, for a period of time; (4) checking, by the workflow task function, a status of the first job with the serverless task/function; (5) receiving, by the workflow task function, the status of the first job; and (6) continuing, by the workflow task function, with a second job for the service provided on the container orchestration system.

In one embodiment, the request forwarder sends the first job and/or the second job to an API associated with the service.

In one embodiment, the serverless task/function may include a Lambda function.

In one embodiment, the first job and/or the second job may be Kubernetes jobs.

In one embodiment, the Kubernetes jobs may include definitions of the Kubernetes jobs.

In one embodiment, the request forwarder may include a NodeJS project.

In one embodiment, the request forwarder may be restricted to calls from specific APIs and/or endpoints.

In one embodiment, the request forwarder may be integrated into an Active Directory Federation Service and Continuous Integration/Continuous Deployment.

In one embodiment, a Kubectl Wrapper API receives the Kubernetes job from the request forwarder. The Kubectl Wrapper API may interface with a Kubernetes job API.

In one embodiment, the service does not have an allow-listable IP address.

According to another embodiment, a system may include: a workflow task function in a cloud environment; a request forwarder comprising a serverless task/function in the cloud environment; and a container orchestration system comprising a wrapper API and a cluster API for a service. The workflow task function may be configured to create a first job for the service provided on the container orchestration system, wherein the workflow task function cannot call the service directly; the workflow task function may be configured to forward the first job to the service as a serverless task/function using the request forwarder; the workflow task function may be configured to wait for a period of time; the request forwarder may be configured to send the first job to an API associated with the service; the workflow task function may be configured to check on a status of the first job with the serverless task/function; the workflow task function may be configured to receive the status of the first job; and the workflow task function may be configured to continue with a second job for the service provided on the container orchestration system.

In one embodiment, the serverless task/function may include a Lambda function.

In one embodiment, the first job and/or the second job may be Kubernetes jobs.

In one embodiment, the Kubernetes jobs may include definitions of the Kubernetes jobs.

In one embodiment, the request forwarder may include a NodeJS project.

In one embodiment, the request forwarder may be restricted to calls from specific APIs and/or endpoints.

In one embodiment, the request forwarder may be integrated into an Active Directory Federation Service and Continuous Integration/Continuous Deployment.

According to another embodiment, a non-transitory computer readable storage medium, including instructions stored thereon, which when read and executed by one or more computer processors, cause the one or more computer processors to perform steps comprising: creating a first job for a service provided on a container orchestration system, wherein the service cannot be called directly; forwarding the first job to the service as a serverless task/function using a request forwarder; waiting for a period of time; checking a status of the first job with the serverless task/function; receiving the status of the first job; and continuing with a second job for the service provided on the container orchestration system.

In one embodiment, the serverless task/function may include a Lambda function, the first job and/or the second job are Kubernetes jobs.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for multi cloud task orchestration according to an embodiment;

FIG. 2 depicts a method for multi cloud task orchestration according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for multi cloud task orchestration. Because workflow task functions cannot call services in a container orchestration system directly, and cannot receive job statuses from the services directly, embodiments provide a mechanism to orchestrate workflow task functions via a request forwarder so that they can be executed.

The service may be any task execution service. Examples include ECS, EKS, or any task execution service across any cloud or non-cloud platform.

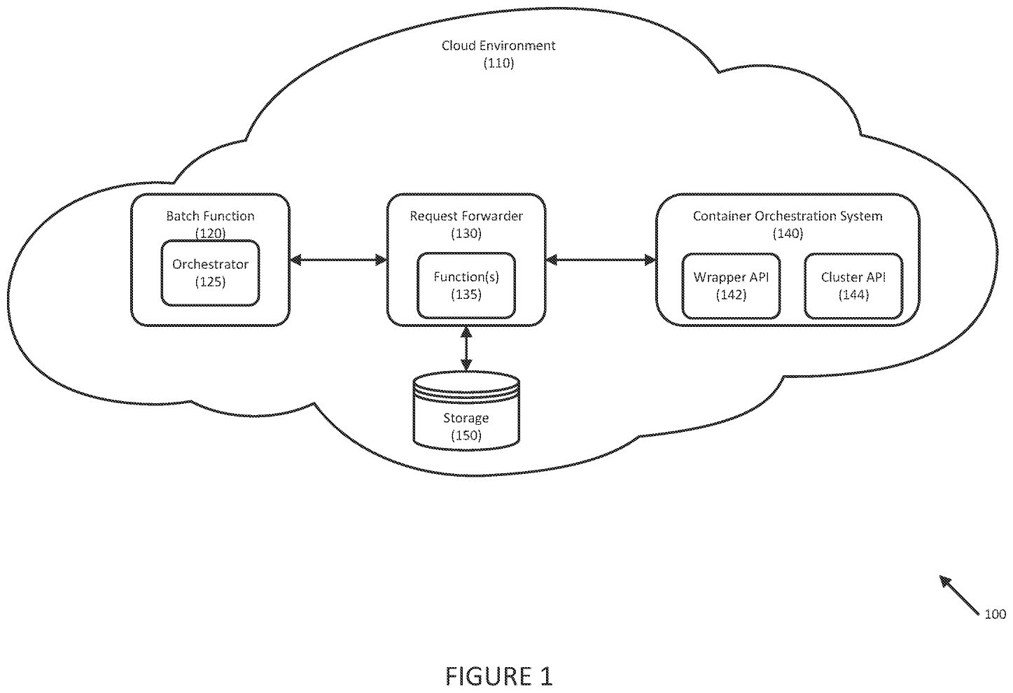

Referring to FIG. 1, embodiments provide a batch orchestration solution for cloud services such as EKS and ECS that may leverage an existing EKS or ECS cluster, workflow task functions (e.g., Step Functions, or SFNs), serverless tasks/functions (e.g., cloud-based tasks/functions, such as Lambda functions), and storage (e.g., cloud storage) if needed. System 100 may include cloud environment 110, which may be an Amazon Web Services (AWS) cloud environment or any suitable cloud environment provided by a cloud provider.

In one embodiment, a specific serverless task/function (e.g., Lambda function) may be provided for each type of job. For example, different serverless tasks/functions may be provided for cloud platforms, including Azure functions, ECS tasks, etc.

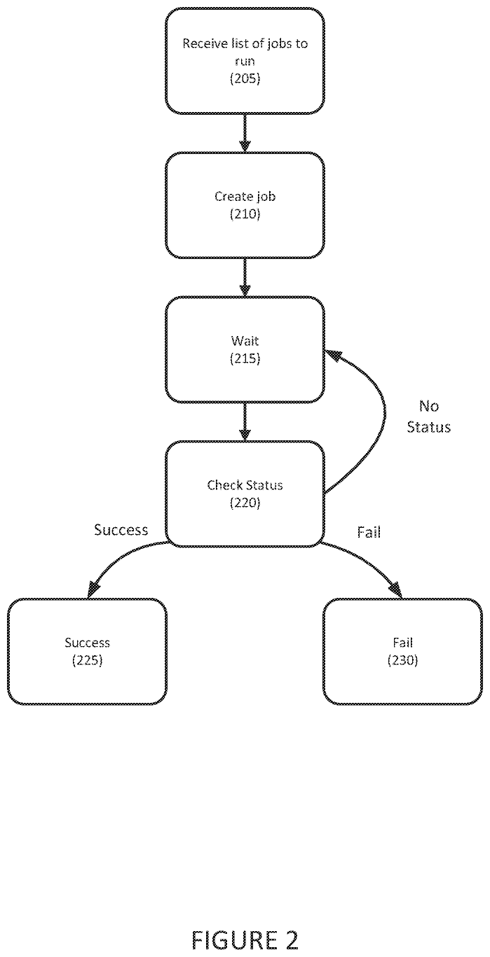

Cloud environment 110 may include batch function 120, request forwarder 130, and container orchestration system 140. An example of a container orchestration system 140 is the Kubernetes platform. Batch function 120 may include orchestrator computer program 125, which may execute a workflow task function. An example of a state diagram for a workflow task function is provided in FIG. 2.

FIG. 2 depicts a state diagram for a workflow task function, such as a step function, according to one embodiment. The workflow task function may include the name of each job intended to run in a daily workflow. For example, in state 205, the workflow task function may receive a list of jobs to run along with a reference to the job definition in storage and, in state 210, may then create the job. The job definition may be hard coded into the workflow task function and may be referred to by key, or it may be retrieved from storage using a key. The workflow task function may then forward the job name to the request forwarder, which may send the job name to a cluster, such as a EKS or ECS cluster.

In one embodiment, the job definition may include the information of the tasks that need to be performed on by the service. For example, for a Kubernetes job, the definition may be Execute task=getCustomerInformationMatching and Input date={today}.

The jobs can be any compute tasks (e.g., Kubernetes, a java program, etc.).

All of the jobs from workflow task function may be sent to a serverless task/function (e.g., a Lambda function) to be executed on target compute (e.g., EKS/ECS).

In state 215, the workflow task function may wait a period of time for the pending job to complete (e.g., 60 seconds or any other suitable period), and in state 220, may poll the serverless task/function for the status of the pending job. If the status is not available, the workflow task function may return to state 215 and wait for a status. If the pending job is successfully completed, the workflow task function may move to state 225, and it may then continue with the next job.

If the pending job is not successfully completed, the workflow task function may move to state 230. In one embodiment, the results may be stored in a log and a notification may be generated. The notification may then be used for an audit.

Referring again to FIG. 1, orchestrator 125 may provide the job to request forwarder 130, such as a Lambda request forwarder. Request forwarder 130 may be a small NodeJS module that forwards requests from the workflow task function in orchestrator 125 to container orchestration system 140. Request forwarder 130 may be provided because the workflow task functions cannot call cloud services in container orchestration system 140 directly as the cloud services have no definitive allow-listable (e.g., accessible) IP addresses. The workflow task function can communicate with function serverless task/function 135 created through, for example, terraform. Workflow task functions may also call cloud services deployed to container orchestration system 140.

Thus, because the cloud services have no definitive allow-listable IP addresses, security is maintained while embodiments still allow the cloud services to be accessed.

In one embodiment, request forwarder 130 may read job definitions from storage 150 (e.g., cloud storage) or similar to enable updates without function redeployment. Request forwarder 130 may be integrated into Active Directory Federation Services (ADFS), Continuous Integration and Deployment (Cl/CD) satisfying the risk and compliance and may support job creation and status checks. In embodiments, the request forwarder may restrict calls to specific APIs/endpoints.

Wrapper API 142 may be a Spring Boot API deployed to a service that provides access to the cloud service. Wrapper API 142 may also provide a POST endpoint to create new jobs, and a GET endpoint to check the status of running jobs. It may also be integrated into Active Directory Federation Services (ADFS) authentication. Alternatively, wrapper API may use any suitable form of authentication, such as a user id/password, token validation, certificates, etc.

Cluster API 144 may be any compute platform that can execute the required task from wrapper API 142. Wrapper API 142 may provide access to cluster API 144.

Embodiments may provide a configurable execution plan that may be changed dynamically, an execution plan that may span across multiple, public clouds and on-premises platforms, and integrated step functions with services, such as EKS using serverless tasks/functions (e.g., Lambda functions), Rest API and other services (e.g., EKS) in a private subnet.

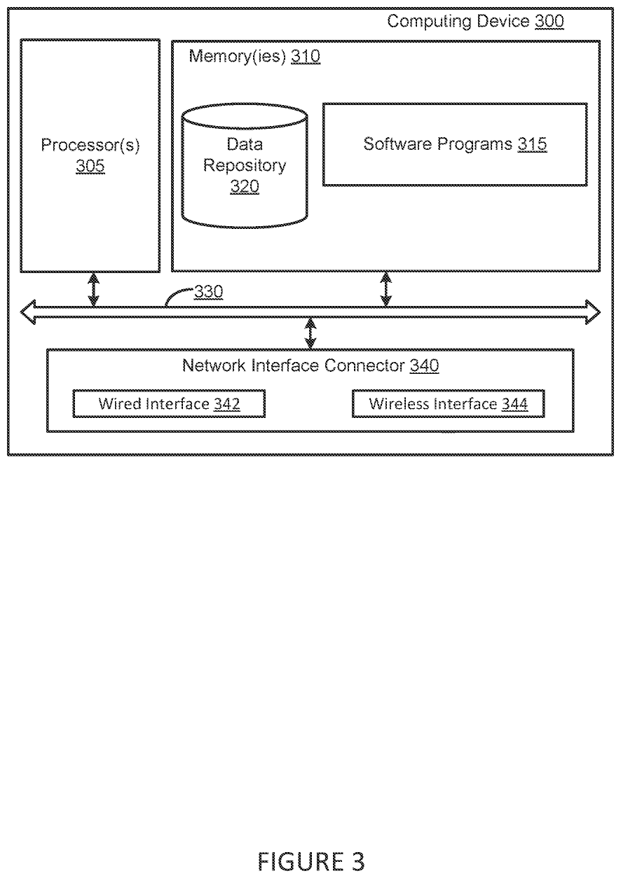

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for multi cloud task orchestration, comprising:
creating, by a workflow task function, a first job for a service provided on a container orchestration system, wherein the workflow task function cannot call the service directly;
forwarding, by the workflow task function, the first job to the service as a serverless task/function using a request forwarder;
waiting, by the workflow task function, for a period of time;
checking, by the workflow task function, a status of the first job with the serverless task/function;
receiving, by the workflow task function, the status of the first job; and
continuing, by the workflow task function, with a second job for the service provided on the container orchestration system.

2. The method of claim 1, wherein the request forwarder sends the first job and/or the second job to an API associated with the service.

3. The method of claim 1, wherein the serverless task/function comprises a Lambda function.

4. The method of claim 1, wherein the first job and/or the second job are Kubernetes jobs.

5. The method of claim 4, wherein the Kubernetes jobs comprises definitions of the Kubernetes jobs.

6. The method of claim 1, wherein the request forwarder comprises a NodeJS project.

7. The method of claim 1, wherein the request forwarder is restricted to calls from specific APIs and/or endpoints.

8. The method of claim 1, wherein the request forwarder is integrated with an Active Directory Federation Service, wherein the Active Directory Federation Service provides authentication services.

9. The method of claim 4, wherein a Kubectl Wrapper API receives the Kubernetes job from the request forwarder.

10. The method of claim 9, wherein the Kubectl Wrapper API interfaces with a Kubernetes job API.

11. The method of claim 1, wherein the service does not have an allow-listable IP address.

12. A system, comprising:
a workflow task function in a cloud environment;
a request forwarder comprising a serverless task/function in the cloud environment; and
a container orchestration system comprising a wrapper API and a cluster API for a service;
wherein:
the workflow task function is configured to create a first job for the service provided on the container orchestration system, wherein the workflow task function cannot call the service directly;
the workflow task function is configured to forward the first job to the service as a serverless task/function using the request forwarder;
the workflow task function is configured to wait for a period of time;
the request forwarder is configured to send the first job to an API associated with the service;
the workflow task function is configured to check on a status of the first job with the serverless task/function;
the workflow task function is configured to receive the status of the first job; and
the workflow task function is configured to continue with a second job for the service provided on the container orchestration system.

13. The system of claim 12, wherein the serverless task/function comprises a Lambda function.

14. The system of claim 12, wherein the first job and/or the second job are Kubernetes jobs.

15. The system of claim 14, wherein the Kubernetes jobs comprises definitions of the Kubernetes jobs.

16. The system of claim 12, wherein the request forwarder comprises a NodeJS project.

17. The system of claim 12, wherein the request forwarder is restricted to calls from specific APIs and/or endpoints.

18. The system of claim 12, wherein the request forwarder is integrated into an Active Directory Federation Service, wherein the Active Directory Federation Service provides authentication services.

19. A non-transitory computer readable storage medium, including instructions stored thereon, which when read and executed by one or more computer processors, cause the one or more computer processors to perform steps comprising:
creating a first job for a service provided on a container orchestration system, wherein the service cannot be called directly;
forwarding the first job to the service as a serverless task/function using a request forwarder;
waiting for a period of time;
checking a status of the first job with the serverless task/function;
receiving the status of the first job; and
continuing with a second job for the service provided on the container orchestration system.

20. The non-transitory computer readable storage medium of claim 19, wherein the serverless task/function comprises a Lambda function, the first job and/or the second job are Kubernetes jobs.
